(19) United States
(12) Patent Application Publication
(10) Pub. No.: US 2021/0237550 A1
(43) Pub. Date: Aug. 5, 2021

(54) VEHICLE BODY LOWER STRUCTURE

(71) Applicants: TOYOTA JIDOSHA KABUSHIKI KAISHA, Aichi (JP); SUBARU CORPORATION, Tokyo (JP)

(72) Inventors: Kyosuke KAWASE, Okazaki-shi (JP); Katsuya OOSHIMA, Tokyo-to (JP); Tatsuya MORINAGA, Tokyo-to (JP)

(21) Appl. No.: 17/152,792

(22) Filed: Jan. 20, 2021

(30) Foreign Application Priority Data
Jan. 30, 2020 (JP) 2020-013578

(51) Int. Cl. B60K 1/04; B60L 50/60

(52) U.S. Cl. CPC B60K 1/04; B60K 2001/0438; B60L 50/66

(57) ABSTRACT

A vehicle body lower structure of an electric vehicle may include: a floor panel of a vehicle body; a battery pack arranged under the floor panel and including a plurality of battery cells; a spacer arranged between and in contact with a top plate and a bottom plate of the battery pack; and a vibration-isolating material arranged between and in contact with the floor panel and the top plate. The spacer may be positioned under the vibration-isolating material, and a space may be provided between the floor panel and the top plate above the plurality of the battery cells.

### CROSS-REFERENCE TO RELATED APPLICATION

This application claims priority to Japanese Patent Application No. 2020-013578 filed on Jan. 30, 2020, the contents of which are hereby incorporated by reference into the present application.

### TECHNICAL FIELD

The technology disclosed herein relates to a vehicle body lower structure of an electric vehicle. The present disclosure relates to a vehicle body lower structure including a floor panel and a battery pack arranged under the floor panel.

### BACKGROUND

An electric vehicle often includes a battery pack arranged under a floor panel. In each of electric vehicles described in U.S. Pat. No. 8833499 and Japanese Patent Application

Publication No. 2017-196959, a vibration-isolating material is arranged between and in contact with a floor panel and a battery pack. In the electric vehicle of U.S. Pat. No. 883499, the vibration-isolating material entirely covers a top of the battery pack. In the electric vehicle of Japanese Patent Application Publication No. 2017-196959, the vibration-isolating material is partly arranged between and in contact with the floor panel and the battery pack. A space is provided adjacent to the vibration-isolating material between the floor panel and the battery pack. Battery cells are stacked on each other. The vibration-isolating material is arranged above an end of the stack in a stack direction. The electric vehicle of Japanese Patent Application Publication No. 2017-196959 includes a first vibration-isolating material and a second vibration-isolating material. The first vibration-isolating material is arranged between and in contact with the end of the stack of the battery cells and a top plate of the battery pack, and the second vibration-isolating material is arranged between and in contact with the top plate of the battery pack and the floor panel. The first vibration-isolating material and the second vibration-isolating material are arranged to overlap when viewing along an up-down direction.

### SUMMARY

Adopting a large vibration-isolating material that entirely covers a top of a battery pack increases cost and weight. In the vehicle body lower structure of Japanese Patent Application Publication No. 2017-196959, the battery cells are located under the vibration-isolating material, and hence a pressure might be excessively applied to the battery cells. The present disclosure provides a vehicle body lower structure further improved in reducing vibration of a battery pack.

A vehicle body lower structure of an electric vehicle disclosed herein may comprise: a floor panel of a vehicle body; a battery pack arranged under the floor panel and including a plurality of battery cells; a spacer arranged between and in contact with a top plate and a bottom plate of the battery pack; and a vibration-isolating material arranged between and in contact with the floor panel and the top plate. The spacer may be positioned under the vibration-isolating material, and a space is provided between the floor panel and the top plate above the plurality of the battery cells.

In the vehicle body lower structure disclosed herein, the spacer and the vibration-isolating material are located to overlap with each other when seen in an up-down direction. The vibration-isolating material reduces vibration of the battery pack. The vibration-isolating material is supported by the bottom plate of the battery pack via the spacer, by which a pressure is not excessively applied to the battery cells. Moreover, the space is provided between the floor panel and the top plate above the battery cells (i.e., the vibration-isolating material does not entirely cover the top plate), which contributes a decreased total weight of the vibration-isolating material.

Details and further improvements of the technique disclosed herein will be described in Detailed Description below.

### BRIEF DESCRIPTION OF DRAWINGS

FIG. 1 is a perspective view of a floor panel.

FIG. 2 is an exploded view of a battery pack.

FIG. 3 is a cross-sectional view of a vehicle body lower structure (a cross section when seen from a lateral side of a vehicle).

FIG. 4 is a cross-sectional view of the vehicle body lower structure (a cross section when seen from a front of the vehicle).

FIG. 5 is a cross-sectional view of a vehicle body lower structure of a variant (a cross section when seen from a lateral side of the vehicle).

FIG. 6 is a diagram of a spacer of a variant.

### DETAILED DESCRIPTION

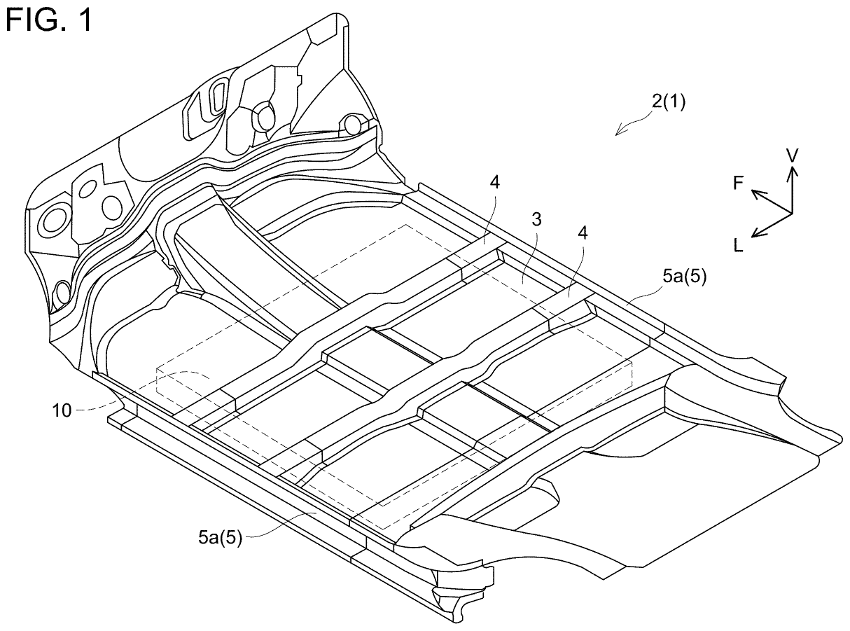

With reference to the drawings, a vehicle body lower structure 2 according to an embodiment will be described. The vehicle body lower structure 2 according to the embodiment is adopted in an electric vehicle 1. FIG. 1 shows a perspective view of a floor panel 3 of the electric vehicle 1. An F-axis in the coordinate system in FIG. 1 indicates a front direction of the vehicle, a V-axis indicates an upper direction of the vehicle, and an L-axis indicates “left” when the vehicle is seen from its rear toward front. Each of the axes in the coordinate system has the same meaning in all of the drawings.

A battery pack 10 is arranged under the floor panel 3. FIG. 1 depicts the battery pack 10 in a simplified manner. The battery pack 10 includes a plurality of battery cells (not shown).

The electric vehicle I includes an electric traction motor (not shown), and the plurality of battery cells is configured to supply electric power to the electric traction motor.

The battery pack 10 is supported by a pair of rockers 5. Each of the rockers 5 is configured of a rocker inner panel 5a and a rocker outer panel 5b. The rocker outer panels 5b are not shown in FIG. 1. The rockers 5 are respectively arranged in lower lateral parts of a vehicle body in a vehicle width direction. Each of the rockers 5 is a hollow beam and extends along a vehicle front-rear direction. The pair of rockers 5 is a one of frames which provides strength required for the vehicle body. The rockers 5 are formed by extrusion molding of metal (typically, aluminum). The rockers may also be called “side sills”.

The floor panel 3 corresponds to a floor of a cabin. The floor panel 3 is supported by the pair of rockers 5. The floor panel 3 is configured of a metal sheet. Parts of the floor panel 3 are bent into inverted channel shapes to form crossmembers 4. The crossmembers 4 extend in the vehicle width direction and are connected to the pair of rockers 5. The crossmembers 4 are ridges that function as beams. The crossmembers 4 enhance strength of the floor panel 3.

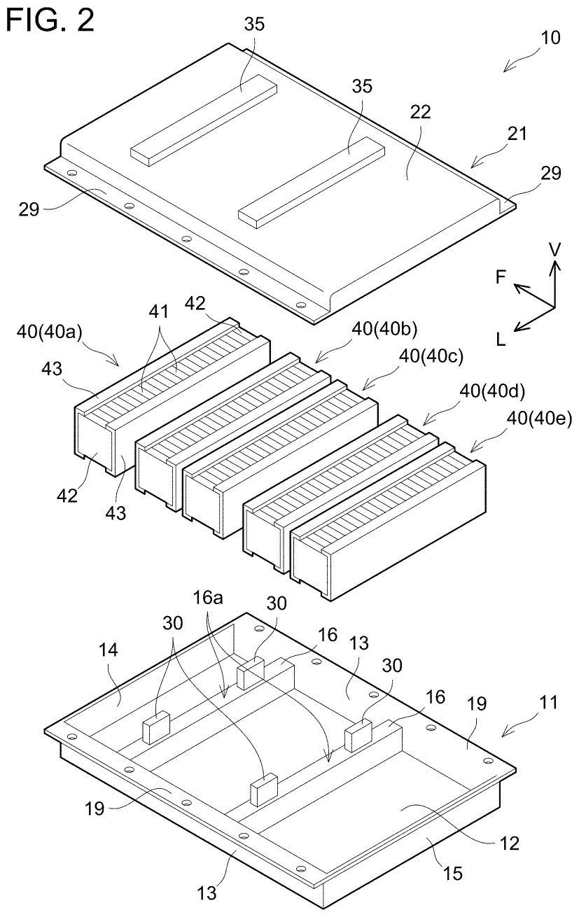

The battery pack 10 will be described. FIG. 2 shows an exploded perspective view of the battery pack 10. The battery pack 10 includes a plurality of battery modules 40 and a container 11 that houses the plurality of battery modules 40. Each of the battery modules 40 includes a plurality of battery cells 41 that are stacked. The battery cells 41 are stacked and end plates 42 are respectively arranged at both ends of the stack of the battery cells 41 in a stack direction. Each stack configured of the plurality of battery cells 41 and the end plates 42 is clamped by a pair of clamps 43. The battery cells 41 are flat. One of the pair of clamps 43 faces narrower side surfaces at one side of the battery cells 41 and clamps ends of the battery cells 41 (upper corners and lower corners of the battery cells 41) from above and below, and the other of the pair of the clamps 43 faces narrower side surfaces at the opposite side of the battery cells 41 and clamps other ends of the battery cells 41 (other upper corners and lower corners of the battery cells 41) from above and below. In FIG. 1, reference signs 41, 42, 43 are allocated only to a frontmost battery module 40a. The reference sign 41 is allocated to some of the battery cells, and the reference sign is omitted for the remaining battery cells.

The plurality of battery modules 40 (the plurality of battery cells 41) are housed in the container 11. In-container crossmembers 16 are formed on a bottom plate 12 of the container 11. Each of the in-container crossmembers 16 is formed by bending the bottom plate 12 into an inverted channel shape (inverted U-shape). The in-container crossmembers 16 are connected to a pair of side plates 13 of the container 11. The in-container crossmembers 16 enhance strength of the container 11.

One battery module 40a is arranged between a front plate 14 of the container 11 and one of the in-container crossmembers 16 that is located frontmost. Two other battery modules 40b, 40c are arranged between two of the in-container crossmembers 16. The remaining battery modules 40d, 40e are arranged between one of the in-container crossmembers 16 located rearmost and a rear plate 15 of the container 11.

Spacers 30 are attached to tops 16a of the in-container crossmembers 16. Two spacers 30 are attached on the top 16a of each in-container crossmember 16. Each spacer 30 is a metal block. Functions of the spacers 30 will be described later. Flanges 19 are provided at both ends of the container 11, respectively .

The container 11 that houses the battery modules 40 is covered with a cover 21. Flanges 29 are provided at both ends of the cover 21, respectively. The flanges 29 of the cover 21 and the flanges 19 of the container 11 are joined together and fixed to each other. Vibration-isolating materials 35 are attached on a top plate 22 of the cover 21.

The vibration-isolating materials 35 are elastic bodies constituted of resin or rubber. The vibration-isolating materials 35 may also be constituted of, for example, a urethane-based foam. The vibration-isolating materials 35 are provided for reducing vibration of the battery pack 10. Further, the vibration-isolating materials 35 not only reduce vibration of the battery pack 10 but also reduce noise transmitted through the floor panel 3 to the cabin. Each of the vibration-isolating materials 35 is elongated and arranged such that its longitudinal direction is along the vehicle width direction. The vibration-isolating materials 35 and the spacers 30 provide features of the vehicle body lower structure 2.

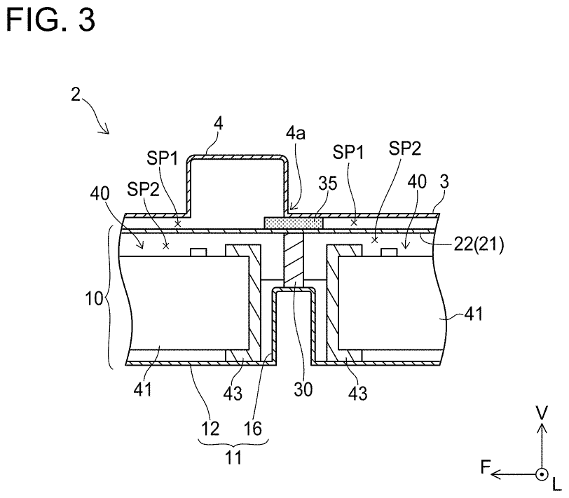

The vehicle body lower structure 2 will be described. FIG. 3 shows a cross-sectional view of the vehicle body lower structure 2. FIG. 3 shows cross sections of the floor panel 3 and the battery pack 10. FIG. 3 is the cross-sectional view of the vehicle body lower structure 2 when it is seen from a lateral side of the vehicle.

As described above, the in-container crossmembers 16 are formed by bending the bottom plate 12 of the container 11. In other words, the in-container crossmembers 16 are parts of the bottom plate 12. The spacers 30 are fixed to the tops 16a of the in-container crossmembers 16. A top of each spacer 30 is in contact with the top plate 22 of the cover 21. Each vibration-isolating material 35 is arranged between and in contact with the top plate 22 and the floor panel 3. Each spacer 30 is arranged under its corresponding vibration-isolating material 35. In other words, the vibration-isolating materials 35 are arranged to overlap the spacers 30 when seen from above.

In the vehicle body lower structure 2 described above, the spacers 30 are arranged between and in contact with the bottom plate 12 (the in-container crossmembers 16) and the top plate 22 of the battery pack 10, and the vibration-isolating materials 35 are arranged between and in contact with the top plate 22 and the floor panel 3. The spacers 30 and the vibration-isolating materials 35 overlap when seen from above. In other words, the vibration-isolating materials 35 physically contact the bottom plate 12 via the top plate 22 and the spacers 30. Vibration of the entire battery pack 10 is damped by the vibration-isolating materials 35. The above-described arrangement effectively reduces vibration of the battery pack 10. Since the vibration-isolating materials 35 are supported by the bottom plate 12 of the container 11 via the top plate 22 and the spacers 30, a pressure is not excessively applied to the battery cells 41.

A space SP1 is provided adjacent to the vibration-isolating materials 35. In other words, the space SP1 is provided between the top plate 22 and the floor panel 3 above the battery cells 41. Further, a space SP2 is provided between the battery cells 41 and the top plate 22.

The vibration-isolating materials 35 only partly cover the top plate 22, which results in a reduced total weight of the vibration-isolating materials 35 as compared to a case where vibration-isolating materials entirely cover the top plate 22. Using the vibration-isolating materials 35 in less amount also reduces the cost.

Each vibration-isolating material 35 also overlaps a base 4a of corresponding one of the crossmembers 4. Each base 4a is a bent part of the floor panel 3, and thus has high strength. Arranging the vibration-isolating materials 35 to overlap the bases 4a having high strength allows the floor panel 3 to hold firmly the vibration-isolating materials 35. Consequently, vibration of the battery pack 10 can be reduced effectively. It should be noted that each of the bases 4a of the crossmembers 4 corresponds to a boundary between the crossmember 4 and the floor panel 3.

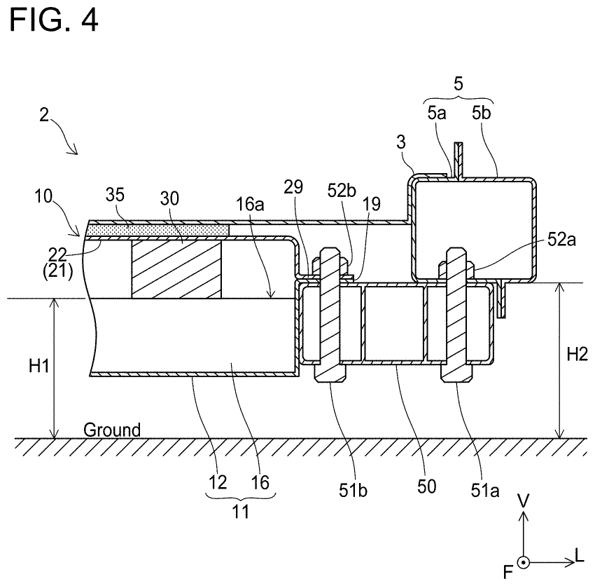

FIG. 4 shows a cross-sectional view of the vehicle body lower structure 2 when it is seen from the front of the vehicle. FIG. 4 also shows a cross section of one of the rockers 5. FIG. 4 does not show the battery modules 40 (the battery cells 41 and the clamps 43).

As described above, each rocker 5 is configured of the rocker inner panel 5a and the rocker outer panel 5b. Each of the rocker inner panel 5a and the rocker outer panel 5b has an angular U-shape and includes flanges respectively at both ends of the U-shape. The flanges of the rocker inner panel 5a and the flanges of the rocker outer panel 5b are joined to each other, by which the rocker inner panel 5a and the rocker outer panel 5b, each of which has a U-shape, configure a hollow beam. An end of the floor panel 3 is joined to the rocker 5.

A hollow beam 50 (which is different from the rocker 5) is fixed to a bottom of the rocker 5 with a bolt 51a and a nut 52a. The beam 50 extends along the rocker 5 in the vehicle front-rear direction. The beam 50 protects the battery pack 10 when an object collides against a lateral side of the vehicle. The beam 50 absorbs energy of the impact of the object colliding against the lateral side of the vehicle, and hence is called an energy absorbing member.

Another beam 50 is also fixed to the other rocker 5 located at the opposite side of the vehicle.

The battery pack 10 is connected to the beam 50. In other words, the battery pack 10 is supported by the rocker 5 via the beam 50. The battery pack 10 is also connected to the beam 50 located at the opposite side of the vehicle. In other words, the battery pack 10 is connected between the pair of beams 50.

The battery pack 10 is adjacent to an inner end of the beam 50 (an end closer to the center of the vehicle). One of the flanges 19 of the container 11 of the battery pack 10, corresponding one of the flanges 29 of the cover 21 of the battery pack 10, and the beam 50 are fastened together with a bolt 51b and a nut 52b.

As shown in FIG. 4, a ground height H1 of the top 16a of the in-container crossmember 16 is lower than a ground height H2 of a top of the beam 50. As described above, the beam 50 absorbs collision energy caused by a lateral collision. Further, each in-container crossmember 16 extends in the vehicle width direction, thereby exhibits great resistance against the lateral collision. Since the ground height H1 of the top 16a of the in-container crossmember 16 is lower than the ground height H2 of the beam 50, the in-container crossmember 16 firmly supports the beam 50 against the lateral collision. The hollow beam 50 is crushed under the impact of the collision, whereas the in-container crossmember 16 resists the impact, the battery pack 10 therefore suffers small damage in the event of the lateral collision.

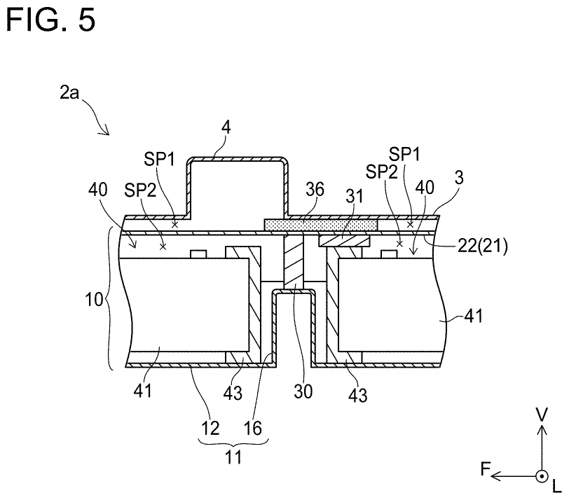

(Variant) A vehicle body lower structure 2a of a variant will be described. FIG. 5 shows a cross-sectional view of the vehicle body lower structure 2a. The cross section of FIG.

5 corresponds to the cross section of FIG. 3. The vehicle body lower structure 2a adopts wider vibration-isolating materials 36. Similar to the vehicle body lower structure 2 according to the embodiment, each spacer 30 is arranged under corresponding one of the vibration-isolating materials 36. Further, an additional spacer 31 is also arranged under each of the vibration-isolation materials 36. Each additional spacer 31 is arranged between the top plate 22 and a top of corresponding one of the clamps 43 clamping the battery cells 41 from above and below. Each additional spacer 31 is in contact not only with the top of the clamp 43 but also with the top plate 22. Each vibration-isolating material 36 is supported by the bottom plate 12 not only via the spacer 30, but also via the additional spacer 31 and the clamp 43. The vibration-isolating material 36 is supported firmly by the bottom plate 12 of the container 11 via the spacer 30 and the additional spacer 31.

The vibration-isolating material 36 is wider than the vibration-isolating material 35 of the embodiment. The space SP1 is provided adjacent to the vibration-isolating material 36. The vehicle body lower structure 2a adopts the additional spacer 31. The space SP2 is provided adjacent to the additional spacer 31 between the battery cells 41 and the top plate 22. The vibration-isolating material 36 do not entirely cover the top plate 22 either, and hence is lightweight and low-cost. Moreover, since the space SP2 is provided also above the battery cells 41, pressure is not excessively applied to the battery cells 41.

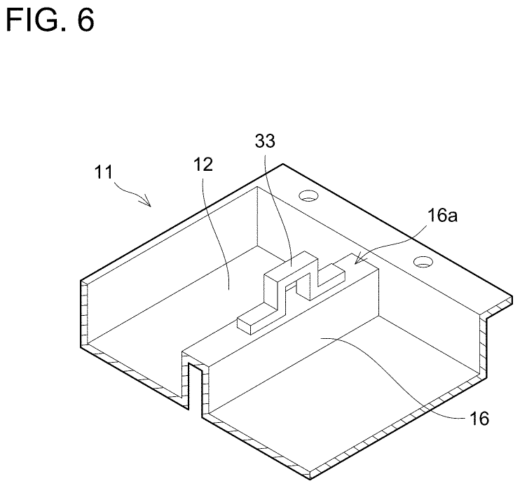

(Variant of Spacer) FIG. 6 shows a spacer 33 of a variant. FIG. 6 is a partial perspective view of the container 11. Similar to the spacer 30 described above, the spacer 33 is fixed to the top 16a of the in-container crossmember 16. The spacer 33 is formed by bending a metal sheet. The spacer may not be a metal block, but may be a bent metal sheet.

Features of the technology described in the embodiment will hereinafter be listed. The space SP2 is provided between the battery cells 41 and the top plate 22, and the space SP1 is provided between the floor panel 3 and the top plate 22 above the space SP2.

The clamps 43 clamp the ends of the battery cells 41 (the upper corners and the lower corners of the battery cells 41) from above and below. The additional spacers 31 are arranged between the clamps 43 and the top plate 22. The additional spacers 31 are respectively arranged under the vibration-isolating materials 36.

The ridges which function as beams (the in-container crossmembers 16) are formed on the bottom plate 12 and extend along the vehicle width direction. The spacers 30 are attached on the ridges (the in-container crossmembers 16). In other words, the spacers 30 are arranged between and in contact with the ridges (the in-container crossmembers 16) and the top plate 22.

Each of the vehicle body lower structures 2, 2a includes the hollow rockers 5 and the hollow beams 50 both extending along the front-rear direction of the vehicle body. Each of the beams 50 extends along the vehicle front-rear direction between corresponding one of the rockers 5 and the battery pack 10. The beams 50 are respectively connected to the rockers 5 and both connected to the battery pack 10. The ground height H1 of the top of each ridge (each in-container crossmember 16) is lower than the ground height H2 of the top of each beam 50.

The electric vehicle herein includes a hybrid vehicle including both of a motor and an engine for traction, and a vehicle including a battery and a fuel cell as power sources.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A vehicle body lower structure of an electric vehicle, the lower structure comprising:
a floor panel of a vehicle body;
a battery pack arranged under the floor panel and including a plurality of battery cells;
a spacer arranged between and in contact with a top plate and a bottom plate of the battery pack; and
a vibration-isolating material arranged between and in contact with the floor panel and the top plate,
wherein
the spacer is positioned under the vibration-isolating material, and
a space is provided between the floor panel and the top plate above the plurality of the battery cells.

2. The vehicle body lower structure of claim 1, wherein an additional space is provided between the plurality of the battery cells and the top plate.

3. The vehicle body lower structure of claim 1, further comprising:
a clamp clamping an end of the plurality of the battery cells from above and below; and
an additional spacer arranged between the clamp and the top plate and positioned under the vibration-isolating material.

4. The vehicle body lower structure of claim 1, wherein
a ridge is formed on the bottom plate and the ridge extends along a vehicle width direction, and
the spacer is arranged on the ridge.

5. The vehicle body lower structure of claim 4, further comprising:
a rocker extending along a front-rear direction of the vehicle body; and
a hollow beam extending along the front-rear direction between the rocker and the battery pack and connected to the rocker and the battery pack,
wherein a ground height of a top of the ridge is lower than a ground height of a top of the hollow beam.
